(19) United States
(12) Patent Application Publication
(10) Pub. No.: US 2007/0141226 A1
(43) Pub. Date: Jun. 21, 2007

(54) Method for Reducing Acrylamide Formation in Thermally Processed Foods

(75) Inventors: Vincent Allen Elder, Carrollton, TX (US); John Gregory Fulcher, Dallas, TX (US); Henry Kin-Hang Leung, Plano, TX (US); Rayford Thomas Smith, Rowlett, TX (US); Michael Grant Topor, Little Elm, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 11/627,748

(22) Filed: Jan. 26, 2007

Related U.S. Application Data
(63) Continuation of application No. 11/344,992, filed on Feb. 1, 2006.
Application No. 11/344,992 is a continuation of application No. 10/247,504, filed on Sep. 19, 2002, now Pat. No. 7,037,540.

(51) Int. Cl. A23L 1/216

(52) U.S. Cl. 426/637

(57) ABSTRACT

A process for reducing the amount of acrylamide in thermally processed foods. In one aspect, the method involves providing a dehydrated food product having asparagine, rehydrating the food product in a solution, and thermally processing the food product. In one aspect, the method involves providing a dehydrated food product having asparagine and rehydrating the food product in a solution having an acrylamide reducing agent.

### BACKGROUND OF THE INVENTION

This application is a continuation-in-part of U.S. patent application Ser. No. 11/344,992 filed on Feb. 1, 2006, which is a continuation of U.S. Pat. No. 7,037,540 entitled, “Method for Reducing Acrylamide Formation in Thermally Processed Foods”, filed Sep. 19, 2002.

1. Technical Field

The present invention relates to a method for reducing the amount of acrylamide in thermally processed foods. This invention permits the production of foods having significantly reduced levels of acrylamide. The method relies on rehydrating a dehydrated food having asparagine.

2. Description of Related Art

The chemical acrylamide has long been used in its polymer form in industrial applications for water treatment, enhanced oil recovery, papermaking, flocculants, thickeners, ore processing and permanent-press fabrics. In very recent times, a wide variety of foods have tested positive for the presence of acrylamide monomer. Acrylamide has especially been found in carbohydrate food products that have been processed at high temperatures. Examples of foods that have tested positive for acrylamide include coffee, cereals, cookies, potato chips, crackers, french-fried potatoes, breads and rolls, and fried breaded meats. Since acrylamide in foods is a recently discovered phenomenon, its mechanism of formation has not been confirmed. But, since the acrylamide monomer is not desired in food products, it would be useful to have a method for its significant reduction or elimination in thermally processed foods.

### SUMMARY OF THE INVENTION

This present invention is a method for reducing the amount of acrylamide in thermally processed food products comprising in one embodiment a method for reducing the level of acrylamide in a potato piece comprising the steps of providing a dehydrated potato piece, rehydrating said potato piece in a rehydration solution to create an asparagine-deficient potato piece, and thermally processing said asparagine-deficient potato piece.

In one embodiment, the present invention provides a method for the reduction of acrylamide in thermally processed foods comprising the steps of providing a plant-based food having a native asparagine concentration contained in a plurality of cell walls, dehydrating said plant-based food to make a dehydrated food, and rehydrating the dehydrated food in a rehydration solution, such that the rehydrated food has a reduced asparagine concentration comprising at least 50% less than the native asparagine concentration. The above, as well as additional features and advantages of the invention will become apparent in the following written detailed description.

### DETAILED DESCRIPTION OF THE INVENTION

The formation of acrylamide in thermally processed foods requires a source of carbon and a source of nitrogen. It is hypothesized that carbon is provided by a carbohydrate source and nitrogen is provided by a protein source or amino acid source. Many plant-derived food ingredients such as rice, wheat, corn, barley, soy, potato and oats contain asparagine and are primarily carbohydrates having minor amino acid components. Typically, such food ingredients have a small amino acid pool, which contains other amino acids in addition to asparagine. There are twenty standard amino acids that are the building blocks of proteins and can be found in these food ingredients including, but not limited to, lysine, alanine, asparagine, glutamine, arginine, histidine, glycine and aspartic acid.

By “thermally processed” is meant food or food ingredients wherein components of the food, such as a mixture of food ingredients, are heated to a food temperature of at least 80° C. Preferably the thermal processing of the food or food ingredients takes place at food temperatures between about 100° C. and 205° C. In one embodiment, a thermally processed food is heated to a food temperature of greater than about 120° C. In one embodiment, the plant-based food is fried in hot oil having a hot oil temperature of between about 300° F. (148° C.) and about 375° F. (190° C.) and more preferably between about 350° F. (177° C.) and about 360° F. (182° C.). In one embodiment, the plant-based food is fried in hot oil to a moisture content of less than about 4% and more preferably between about 1% and about 3% by weight. The food ingredient may be separately processed at elevated temperature prior to the formation of the final food product.

As described herein, a thermally processed food can be formed from a thermally processed food ingredient, and/or a raw food ingredient. An example of a thermally processed food ingredient is potato flakes, which is formed from raw potatoes in a process that exposes the potato to temperatures as high as 200° C. Examples of other thermally processed food ingredients include processed oats, par-boiled and dried rice, cooked soy products, corn masa, roasted coffee beans and roasted cacao beans. Exemplary raw food ingredients include raw potato slices, which can be thermally heated to make potato chips or French fries, for example, by frying the raw potato slices at a temperature of from about 100° C. to about 205° C.

Heating amino acids such as lysine and alanine in the presence of a simple sugar such as glucose does not lead to the formation of acrylamide. (See e.g., Examples 1 and 2). However, significant acrylamide formation has been found to occur when the amino acid asparagine is heated in the presence of a simple sugar. (See e.g., Example 3). But, surprisingly, the presence of asparagine with another amino acid, such as lysine, in the presence of a simple sugar does cause an increase in the formation of acrylamide that is much greater than when asparagine is the only amino acid present. (See e.g., Example 4).

Having established that acrylamide forms when asparagine is heated in the presence of a simple sugar, a reduction of acrylamide in thermally processed foods can be achieved by inactivating the asparagine. By “inactivating” is meant removing asparagine from the food or rendering asparagine non-reactive along the acrylamide formation route by means of conversion or binding to another chemical that interferes with the formation of acrylamide from asparagine. For example, asparagine may be inactivated by leaching. The solubility of asparagine in an aqueous solution will be facilitated when the pH of the solution is maintained as slightly acidic or slightly basic, preferably between a pH of 5 and 9. Asparagine may also be inactivated by fermentation. Further still, asparagine can be inactivated by incorporation into proteins. Asparagine may also be inactivated by the addition of a divalent cation such as calcium in the form of calcium lactate, calcium citrate or calcium malate.

An additional method for inactivating is to contact asparagine with the enzyme asparaginase. The asparaginase decomposes asparagine to aspartic acid and ammonia. An exemplary embodiment of the use of asparaginase is illustrated in Example 5.

Still another method for inactivating asparagine comprises treating food by dehydrating it, then rehydrating it, which results in the treated food having a lower concentration of asparagine than the same food left untreated. Such method is illustrated by Examples 6-8, and by the following description.

According to one such exemplary method, the food comprises raw potato pieces made from potatoes that, prior to dehydration, are optionally peeled and sliced to a suitable thickness to make potato chips. Such raw potato pieces can be blanched or left unblanched prior to dehydration.

Suitable dehydrated potato pieces are commercially available from vendors such as Harmony House Foods of Winterville, N.C. Alternatively, raw potato pieces, which typically have a native moisture content of about 70% to about 80%, can be dehydrated by one or more moisture removal methods well known in the art including, but not limited to, infrared ovens, microwave ovens, and convection ovens. Those skilled in the art are well aware of methods for dehydrating food pieces. As used herein, dehydration is defined as a water removal process in a non-oil medium that removes sufficient water such that when the dehydrated piece of food is rehydrated, it has about 50% less asparagine than the food piece had prior to dehydration. As used herein, a dehydrated food piece is any food piece that is dehydrated such that at subsequent rehydration the food piece comprises an asparagine-deficient food. As used herein, an asparagine-deficient food comprises about 50% less and more preferably about 70% less and most preferably about 90% less of the asparagine concentration of the food piece prior to dehydration.

It has been surprisingly found that treated potato pieces, which are defined as dehydrated potato pieces that have been rehydrated, have a lower concentration of asparagine than untreated potato pieces. As used herein, an untreated food piece is a fresh food piece that has not been dehydrated.

Any suitable dehydration method and temperature/time profile can be used so long as the asparagine level after rehydration is at least about 50% less than the native level of asparagine. In one embodiment, the dehydration step occurs at or below ambient pressures in a freeze drying step. In one embodiment, the dehydration occurs at ambient pressure under relatively low heat conditions, e.g. at an oven temperature of less than about 165° F. (74° C.), and in one embodiment, between about 71° C. and about 74° C. for between about 45 minutes to about one hour until the moisture content is less than about 5% by weight, more preferably less than about 4% by weight, even more preferably less than about 3% by weight, and most preferably between about 1 % and about 2% by weight. Of course the above numbers are provided for purposes of illustration and not limitation. The above merely provides an example of a suitable dehydration method and temperature/time profile. Those skilled in the art, armed with this disclosure, will undoubtedly be able to discover other suitable dehydration methods with various mediums including microwave, infrared, convection and others known in the ail at ambient or other pressure and having temperature/time profiles that can reduce the level of asparagine to about 50% of the native level in a food product upon subsequent rehydration.

In one embodiment, the food piece is dehydrated under low heat conditions at ambient pressure. Consequently, at ambient pressures a low heat condition is defined as dehydrating a food piece at an oven temperature of between about 110° F. (43° C.) and about 165° F. (74° C.) to a desired dehydration level. Oven temperatures above 165° F. (74° C.) at ambient pressures can cause the cell walls to become undesirably ruptured. As used herein, a low heat condition is a dehydration profile that results in a dehydrated food piece without cooking the food piece. Such low heat condition may partially gelatinize the starch within the potato cells, but fails to break the intercellular bonds between the potato cells or rupture the cell walls.

According to one example of the present embodiment, dehydrated potato pieces are rehydrated in a rehydration solution. The rehydration solution can be kept at any suitable temperature range and the potato pieces can be kept in the solution for the amount of time required to result in an asparagine-deficient potato piece. In one embodiment, the rehydration solution comprises a rehydration solution temperature range of between about 1° C. and about 18° C. and more preferably between about 7° C. and about 12° C. Such temperature range has advantageously been found to provide crisp, firm potato slices after rehydration. During rehydration it is theorized that the acrylamide pre-cursor asparagine leaches out of the potato piece. Consequently, the potato piece should be rehydrated at least until the potato piece comprises about 50% less and more preferably about 70% less and most preferably about 90% less of the native asparagine level of the untreated potato piece. In one embodiment, the dehydrated potato pieces are rehydrated to a moisture content of between about 30% moisture by weight and about 80% by weight.

According to one embodiment, the rehydration solution comprises water. According to another embodiment, the rehydration solution further comprises one or more acrylamide reducing agents. Because asparagine is a pre-cursor of acrylamide, an asparagine reducing agent is synonymous with an acrylamide reducing agent, since those physical or chemical treatments which reduce asparagine will also result in a reduced level or concentration of acrylamide because there is less asparagine available to be converted into acrylamide. However, it should be pointed out that the reverse may not be true, e.g., some acrylamide reducing agents may destroy the acrylamide molecule after formation of the acrylamide molecule.

That being said, in certain embodiments, the rehydration solution comprises one or more acrylamide reducing agents selected from asparaginase, one or more free thiols, optionally with a reducing agent, said free thiols selected from cysteine, N-acetyl-L-cysteine, N-acetyl-cysteamine, glutathione reduced, dithiothreitol, and casein; one or more amino acids selected from cysteine, lysine, glycine, histidine, alanine, methionine, glutamic acid, aspartic acid, proline, phenylalanine, valine, and arginine; and one or more pH lowering salts having a pKa of less than about 6.0. Such salts include, but are not limited to, calcium chloride, calcium lactate, calcium malate, calcium gluconate, calcium phosphate monobasic, calcium acetate, calcium lactobionate, calcium propionate, calcium stearoyl lactate, magnesium chloride, magnesium citrate, magnesium lactate, magnesium malate, magnesium gluconate, magnesium phosphate, magnesium sulfate, aluminum chloride hexahydrate, aluminum chloride, ammonium alum, potassium alum, sodium alum, aluminum sulfate, ferric chloride, ferrous gluconate, ferrous fumarate, ferrous lactate, ferrous sulfate, cupric chloride, cupric gluconate, cupric sulfate, zinc gluconate, and zinc sulfate. These acrylamide reducing agents are discussed in U.S. patent application Ser. No. 11/033,364, which is hereby incorporated by reference. In the event there is any conflict between the incorporated application and this disclosure, this disclosure controls.

Several embodiments of the invention are illustrated in the examples set forth below:

### EXAMPLE 1

This example demonstrates that acrylamide is not formed in the presence of a simple sugar and the amino acid lysine. About 0.2 grams of glucose was combined with about 0.1 grams of the amino acid L-lysine hydrate and 0.2 mls of water in a 20-ml headspace vial. The vial was covered with aluminum foil and heated in a gas chromatographic oven with the following temperature profile: initial temperature setting of 40° C.; the temperature was then increased 20° C. per minute to 200° C.; there was a two-minute hold at 200° C.; after which the vial was allowed to cool to 40° C.. After heating, the mixture had dried out and turned black. The reaction mixture was extracted with one hundred milliliters of water and acrylamide in the water was measured by GC-MS. When glucose was heated with L-lysine hydrate, acrylamide was not detected (detection limit less than 50 parts per billion). If the Maillard reaction was the source of acrylamide, then the lysine reaction mixture should have contained acrylamide because the reaction mixture was extensively browned.

### EXAMPLE 2

This example demonstrates that acrylamide is not formed in the presence of a simple sugar and the amino acid alanine. The method of Example 1 was repeated except the amino acid used was L-alanine. Again, acrylamide could not be measured above the detection limit of 50 parts per billion.

### EXAMPLE 3

This example demonstrates the formation of acrylamide in the presence of a simple sugar and asparagine. Example 1 was again repeated except that the amino acid was L-asparagine monohydrate. When the reaction mixture was extracted with water and acrylamide measured by GC-MS, the reaction mixture was measured to have 55,106 parts per billion acrylamide. Based on the initial charge of 0.1 gram of asparagine, this represents about a 9% yield of acrylamide.

### EXAMPLE 4

This example demonstrates the formation of acrylamide in the presence of a simple sugar, asparagine and a second amino acid. Example 1 was repeated except that equal parts of L-lysine hydrate and L-asparagine monohydrate were each present in an amount of 0.1 grams. The reaction mixture was tested for acrylamide and acrylamide was found at a level of 214,842 parts per billion. Based on the initial charge of asparagine and lysine, this represents about a 37% yield of acrylamide.

### EXAMPLE 5

The reduction of acrylamide formation when asparagine and glucose are heated in the presence of the enzyme asparaginase is demonstrated in this example. The enzyme asparaginase was dissolved in 0.05 M tris-hydrochloric acid buffer at ph 8.6 to make an active asparaginase solution. A control asparaginase solution was also made by heating a portion of the active asparaginase solution at about 100° C. for about 20 minutes to deactivate the enzyme. In the control, about 0.2 grams glucose, about 0.1 gram asparagine and about 20 mils of the heated asparaginase solution were combined in a 20-ml headspace vial. In the active enzyme experiment, 0.2 grams of glucose, 0.1 grams asparagine and 20 mils of active asparaginase solution were combined in a 20-ml headspace vial. The amount of enzyme in the vial was 250 enzyme units. The control and active enzyme mixtures were processed together in duplicate. The vials were kept at about 37° C. for about 2 hours, then placed in an 80° C. oven for about 40 hours to evaporate to dryness. After heating, 0.2 ml of water was added to each vial. The vials were then heated in a gas chromatographic oven with the following temperature profile: proceeding from an initial temperature of 40° C.; heating 20° C. per minute to about 200° C.; and holding at about 200° C. for about 2 minutes before cooling to about 40° C. The reaction mixtures were then extracted with 50 ml water and acrylamide in the water was measure by GC-MS. The values measured are shown in Table 1 below:

TABLE 1
ACRYLAMIDE FORMATION IN THE PRESENCE OF
ASPARAGINASE AND GLUCOSE

| Test Material | Acrylamide (ppb) | Percent Reduction |
|---|---|---|
| Control 1 | 334,810 | — |
| Control 2 | 324,688 | — |
| Active Asparaginase 1 | 66 | 99.9 |
| Active Asparaginase 2 | 273 | 99.9 |

As can be seen, treatment of the system with an enzyme that decomposes asparagine to aspartic acid and ammonia reduced acrylamide formation by more than 99.9%. This experiment establishes that reducing the concentration of asparagine, or the reactive nature or asparagine, will reduce acrylamide formation.

### EXAMPLE 6

This example demonstrates that the decrease in the asparagine concentration for a treated (dehydrated/rehydrated) potato slice is much greater than that of an untreated potato slice. Fresh potatoes were peeled and sliced to a total thickness of about 0.070 inches. Two sets of dehydrated potato slices having a pre-dehydrated slice thickness of about 0.070 inches and having an initial moisture content of about 3.7% by weight from Harmony House Foods were rehydrated in about 4-liters of a rehydration solution at about 48° F. (9° C.) for about 24 hours and reached a moisture content of about 71% by weight. The first set consisted of about 200 grams of dehydrated slices rehydrated in about 4 liters of water having no enzyme and the second set consisted of about 200 grams of dehydrated slices rehydrated in about 4 liters of water having about 40,000 units of the enzyme asparaginase.

Two samples from each of the three batches were analyzed for asparagine. The average values for each measured batch are shown in Table 2 below.

TABLE 2
ASPARAGINE LEVELS OF REHYDRATED POTATO SLICES

| Test Material | Asparagine (nmol/g) | % Reduction |
|---|---|---|
| Untreated Potatoes Soaked in | 522.52 | — |
| Water | | |
| Dehydrated Potato Slice | 71.34 | 86.3% |
| Rehydrated in Water | | |
| Dehydrated Potato Slice | 1.68 | 99.7% |
| Rehydrated in Enzyme | | |

As demonstrated by the test results, dehydrated potato slices in a water solution reduced the asparagine concentration by about 86% more than the same amount of untreated potato slices soaked in the same amount of water solution. Rehydrating the dehydrated potato slices in an asparaginase solution reduced the asparagine concentration by about 99% more than the same amount of untreated potato slices soaked in the same amount of water solution.

### EXAMPLE 7

This example demonstrates that the decrease in the asparagine concentration during a rehydration step is much greater for a dehydrated potato slice than an untreated potato slice. Further, the Example also demonstrates that non-detect levels of acrylamide in a fried potato slice can be achieved in accordance with one embodiment of the present invention.

About 200 grams of untreated potatoes were sliced to a thickness of about 0.053 inches and soaked in about 7 liters of water having no enzyme at a temperature of about 45° F. (7° C.) for about 5 hours. Both the potato slice and the water were then tested for asparagine. The water revealed an asparagine concentration of 15.46 nmol/g and the potato slice revealed an asparagine concentration of 355.9 nmol/g, indicating that a relatively low level of asparagine leaches out of raw potato slices when the raw potato slices are soaked in a chilled solution.

Dehydrated slices were prepared by heating the slices having an initial thickness of about 0.053 inches at an oven temperature of about 165° F. (74° C.) for about 50 minutes to a moisture content of about 2-3% by weight. For comparative purposes some of these slices were rehydrated in a water solution and some were rehydrated in an enzyme solution. About 200 grams of dehydrated potato slices having an original or pre-dehydration thickness of about 0.053 inches were rehydrated to a moisture content of about 68% to about 70% by weight in about 7 liters of water having no enzyme at a temperature of about 45° F. (7° C.) for about 5 hours. Both the rehydrated potato slice and the water were then tested for asparagine. The water revealed an asparagine concentration of 202.51 nmol/g and the rehydrated potato slice revealed an asparagine concentration of 64.88 nmol/g indicating that a much higher level of asparagine leaches out of dehydrated potato slices than the raw potato slices under the same soaking conditions.

Next, about 200 grams of dehydrated potato slices were rehydrated to a moisture content of about 68% to about 70% by weight in an enzyme solution that comprised about 40,000 units of enzyme in about 7 liters of water at about 45° F. (7° C.) for about 5 hours to a moisture content of about 68% to about 70% by weight. The resultant potato slices revealed an asparagine concentration of 0.17 nmol/gram. The resultant potato slices were next fried at about 353° F. (178° C.) in corn oil for two minutes ten seconds (2:10) to a moisture content of about 2.1% and tested for acrylamide. The acrylamide level was below the detection limit of about 10 parts per billion. All results for Example 7 are shown in Table 3 below, where “−” indicates the measurement was not taken and “ND” indicates less than about 10 parts per billion.

TABLE 3
ASN AND AA LEVELS OF REHYDRATED POTATO SLICES
AND REHYDRATION SOLUTION

| | Asparagine | Asparagine | |
|---|---|---|---|
| | (nmol/g) | (nmol/g) | Acrylamide |
| Test Material | (Potato) | (Solution) | (ppb) |
| Untreated Potatoes Slices | 355.90 | 15.46 | — |
| (Control) | | | |
| Potato Slices Rehydrated in | 64.88 | 202.51 | — |
| water | | | |
| Potato Slices Rehydrated in | 0.17 | — | ND |
| Enzyme | | | |

In the embodiment shown, the level of asparagine leached from potato slices placed into a water solution is an order of magnitude higher with the dehydrated potato slices than untreated potato slices (202.51 v. 15.46). Consequently, the level of asparagine remaining in a rehydrated potato slice that has been soaked in a water solution is much lower than the untreated potato soaked in the same water solution. Rehydrating the dehydrated potato slices in an asparaginase solution reduced the asparagine concentration by more than 99.9% than the same amount of raw potato slices soaked in the same amount of water solution. Further, when the potato slices rehydrated in a potato solution were fried at about 353° F. (178° C.) to a moisture content of about 2.1%, the level of acrylamide was below detectable limits of 10 ppb. This experiment establishes that rehydrating a dehydrated potato slice either in water or in asparaginase will reduce acrylamide formation.

### EXAMPLE 8

This example demonstrates the comparative reduction levels of asparagine in dehydrated potato slices rehydrated for various tines in a water and acrylamide reducing solution having asparaginase. This example further illustrates the concurrent reduction in the acrylamide concentration for a fried potato slice made from a treated (rehydrated dehydrated) potato slice.

To make treated potato slices, fresh potato slices having a slice thickness of about 0.053 inches were dehydrated at an oven temperature of about 165° F. (˜74° C.) for one hour to a moisture content of about 4% to about 5% by weight. The dehydrated potato slices were re-hydrated for various time increments (5 minutes, 30 minutes, 60 minutes, and 2 hours) in a 14 liters of solution (a water-only solution and an enzyme solution having about 40,000 units of asparaginase) at about 43° F. (6° C.). Following rehydration, both the potato slices and the rehydration solution were each tested for levels of asparagine. Some of the resultant treated potato slices were fried at about 353° F. (178° C.) in corn oil for about two minutes thirty seconds to two minutes forth seconds (2:30 to 2:40) to moisture contents of about 1.3% to about 1.4% by weight and tested for acrylamide. The results are shown in Table 4 below.

TABLE 4
ASPARAGINE AND ACRYLAMIDE LEVELS OF
REHYDRATED POTATO SLICES

| | | Asparagine | | |
|---|---|---|---|---|
| | | (nmol/g) in | Asparagine | |
| Rehydration | Rehydration | Rehydration | (nmol/g) in | Acrylamide |
| time | Solution | Solution | Potato Slice | (ppb) |
| 5 minutes | Water | 0.17 | 538.35 | — |
| 5 minutes | Asparaginase | 0.02 | 451.38 | — |
| 30 minutes | Water | 44.03 | 86.96 | — |
| 30 minutes | Asparaginase | 0.19 | 84.84 | 50.8 |
| 60 minutes | Water | 49.73 | 17.33 | 20.6 |
| 60 minutes | Asparaginase | 0.13 | 0.62 | <10 |
| 120 minutes | Water | 53.36 | 13.93 | — |
| 120 minutes | Asparaginase | 0.11 | 0.42 | — |

As can be seen from table 4 above, providing dehydrated potato slices that are subsequently rehydrated leaches asparagine into the rehydration solution at a fairly rapid rate in relatively cool water about 43° F. (6° C.). This experiment establishes that rehydrating a dehydrated potato slice in water or in asparaginase will reduce acrylamide formation. For example, prior art fried potato chips typically have acrylamide concentration of about 250 ppb to about 800 ppb. This experiment establishes that, by flying a treated potato slice, acrylamide can be reduced by almost 80% by first rehydrating dehydrated potato slices in a cool asparaginase solution for only 30 minutes. This is assuming the similar untreated potato slice has an acrylamide concentration of only 250 ppb. ([250-50.8]/250). Further, acrylamide can be reduced by over 90% by rehydrating the potato slice in relatively cool water solution for only 60 minutes. Placing an asparagine reducing compound, such as asparaginase, into the rehydration solution can further enhance the preferential leaching of asparagine from the potato piece into the rehydration solution. A similar untreated potato slice has an acrylamide concentration of only 250 ppb. ([250-20.6]/250). These reductions are conservative since they are based on reductions assuming a 250 ppb control. Higher acrylamide concentrations are in potato chips are common. (See for example, http.//www.cfsan.fda.gov/˜dms/acrydata.html). Further, in one embodiment, e.g., rehydrating in a relatively cool enzyme solution for 60 minutes, the present invention provides a way to make a fried potato chip having an acrylamide level that is non-detectable by current day instrumentation and has an acrylamide level of less than 10 parts per billion.

Without being limited or bound by theory, it is believed that the cellular structure is weakened (but not ruptured) during dehydration. The weakening of the cell walls facilitates leaching of asparagine during subsequent rehydration. Thus, the levels of asparagine are much higher in the rehydration solution where dehydrated potato slices are rehydrated than in the rehydration solution where untreated, raw potatoes are rehydrated. Regardless of the mechanism, the present invention provides a way to make an asparagine-deficient food piece from an asparagine containing food piece.

In embodiment, the present invention is directed towards reducing acrylamide in non-fabricated food products made from unmashed raw foods that are optionally peeled and cut into slices (e.g. potato slices), cubes, wedges, or French fry-like sticks of suitable size. As used herein, an unmashed food piece is a food piece that has had no ricing, comminuting, or mashing of the food piece before the rehydration step. In one embodiment, French-fry like sticks have cross-sectional widths of about 5 millimeters (mm) to about 6 mm. In yet another embodiment, potato pieces comprise potatoes cut into slabs of, for example, about 1 mm to about 3 mm depth, about 50 mm to about 100 mm length and about 20 mm to about 50 mm width or other suitable size known in the art. Because the French-fry like sticks, wedges, and slabs have different geometries, surface area to volume ratios, etc. than slices, the dehydration and rehydration times disclosed in each unit operation below may require adjustments.

One advantage provided by one or more embodiments of the present invention is the relatively cool temperature (e.g., between about 1° C. and about 18° C.) at which effective leaching can occur. Prior to this discovery, it was believed that elevated temperatures, e.g., temperatures above ambient were required to effectively leach asparagine.

Other techniques will be evident to those skilled in the art to effect the inactivation of asparagine in a way that interferes with the formation of acrylamide. With lower levels of asparagine in the food ingredient or the food product prior to thermal processing, the level of acrylamide in the final processed food will be dramatically reduced.

In addition to inactivating asparagine, plant-derived food ingredients can also be sourced from plants that are bred and selected for having asparagine levels that are lower than those of other similar plants. A reduction in the amount of asparagine in the plant-derived food ingredient will be reflected in the amount of acrylamide that is formed under the same conditions of thermal treatment.

While the invention has been particularly shown and described with reference to one embodiment, it will be understood by those skilled in the art that various other approaches to the reduction of acrylamide may be made without departing from the spirit and scope of this invention. The present invention can be applied towards any plant-based food or consumable, such as coffee, having asparagine.

1. A method for reducing the level of acrylamide in a potato piece comprising the steps of:
a) providing an unmashed dehydrated potato piece;
b) rehydrating said potato piece in a rehydration solution to create a rehydrated potato piece; and
c) thermally processing said rehydrated potato piece.

2. The method of claim 1 wherein said dehydrated potato piece at step a) comprises a sliced potato.

3. The method of claim 1 wherein said dehydrated potato piece at step a) comprises French-fry like sticks.

4. The method of claim 1 wherein said dehydrated potato piece comprises a raw potato piece that is dehydrated under low heat conditions at ambient pressure.

5. The method of claim 1 wherein said dehydrated potato piece is dehydrated at an oven temperature of less than about 74° C.

6. The method of claim 1 wherein said dehydrated potato piece comprises a moisture content of less than about 3% by weight.

7. The method of claim 1 wherein said rehydration solution at step b) comprises asparaginase.

8. The method of claim 1 wherein said rehydration solution at step b) comprises one or more free amino acids selected from cysteine, lysine, glycine, histidine, alanine, methionine, glutamic acid, aspartic acid, proline, phenylalanine, valine, and arginine.

9. The method of claim 1 wherein said rehydration solution at step b) comprises one or more free thiols selected from cysteine, N-acetyl-L-cysteine, N-acetyl-cysteamine, glutathione reduced, dithiothreitol, and casein.

10. The method of claim 9 wherein said rehydration solution at step b) further comprises a reducing agent.

11. The method of claim 1 wherein said rehydration solution at step b) further comprises one or more pH lowering salts having a pKa of less than about 6.0.

12. The method of claim 1 wherein said rehydration solution comprises a temperature of between about 7° C. and about 18° C.

13. The method of claim 1 wherein said thermal processing at step c) comprises frying in hot oil.

14. The method of claim 1 wherein said thermal processing at step c) comprises heating the rehydrated potato piece to a potato piece temperature of between about 120° C. and about 205° C.

15. A method for the reduction of acrylamide in thermally processed foods comprising the steps of:
a) providing a plant-based food having a native asparagine concentration;
b) dehydrating said plant-based food to make a dehydrated food such that a reduced asparagine concentration after step c) comprises at least 50% less than said native asparagine concentration; and
c) rehydrating said dehydrated food in a rehydration solution to make a rehydrated food wherein said rehydration solution comprises at least one acrylamide reducing agent.

16. The method of claim 15 wherein the plant-based food at step a) comprises potato.

17. The method of claim 15 wherein said dehydrating at step b) occurs under low heat conditions at ambient pressure.

18. The method of claim 15 wherein said dehydrating at step b) occurs at a food temperature at less than about 74° C.

19. The method of claim 15 wherein said dehydrated food at step b) comprises a moisture content of less than about 3% by weight.

20. The method of claim 15 wherein said rehydration solution at step c) comprises asparaginase.

21. The method of claim 15 wherein said rehydration solution at step c) comprises one or more free amino acids selected from cysteine, lysine, glycine, histidine, alanine, methionine, glutamic acid, aspartic acid, proline, phenylalanine, valine, and arginine.

22. The method of claim 15 wherein said rehydration solution at step c) comprises one or more free thiols selected from cysteine, N-acetyl-L-cysteine, N-acetyl-cysteamine, glutathione reduced, dithiothreitol, and casein.

23. The method of claim 15 wherein said rehydration solution at step c) further comprises a reducing agent.

24. The method of claim 15 wherein said rehydration solution at step c) further comprises one or more pH lowering salts having a pKa of less than about 6.0.

25. The method of claim 15 wherein said rehydration solution comprises a temperature of between about 1° C. and about 18° C.

26. The method of claim 15 further comprising the step of frying said rehydrated food in hot oil.

27. The method of claim 15 further comprising the step of thermally processing said rehydrated food to a food temperature of between about 120° C. and about 205° C.
